(19) United States
(12) Patent Application Publication
(10) Pub. No.: US 2004/0237066 A1
(43) Pub. Date: Nov. 25, 2004

(54) Software design system and method

(75) Inventors: John Grundy, Auckland (NZ); John Gordon Hosking, Aukland (NZ); Yuhong Cai, Auckland (NZ)

Correspondence Address: NIXON & VANDERHYE, PC, 1100 N GLEBE ROAD, 8TH FLOOR, ARLINGTON, VA, 22201-4714, US

(73) Assignee: Auckland UniServices Limited, Auckland (NZ)

(21) Appl. No.: 10/826,381

(22) Filed: Apr. 19, 2004

(30) Foreign Application Priority Data
Apr. 17, 2003 (NZ) NZ 525409

(51) Int. Cl. G06F 9/44

(52) U.S. Cl. 717/104

(57) ABSTRACT

A method of generating a high level design of a distributed system test bed comprising the steps of defining a meta-model of the test bed; defining at least two architecture modelling elements within the meta-model to form an architecture model associated with the meta-model; defining at least one relationship between a pair of architecture modelling elements; defining properties associated with at least one of the architecture modeling elements; and storing the high level design in computer memory.

### FIELD OF INVENTION

The invention relates to a software design system and method. More particularly the invention relates to a software design tool for providing encoding of detailed software architecture information for generation of performance test beds.

### BACKGROUND TO INVENTION

Most system development now requires the use of complex distributed system architectures and middleware. Architectures may use simple 2-tier clients and a centralised database, may use 3-tier clients, an application server and a database, may use multi-tier clients involving decentralised web, application and database server layers and may use peer-to-peer communications. Middleware may include socket (text and binary protocols); Remote Procedure (RPC) and Remote Method Invocation (RMI), DCOM and CORBA, HTTP and WAP, and XML-encoded data.

Data management may include relational or object-oriented databases, persistent objects, XML storage and files. Integrated solutions combining several of these approaches, such as J2EE and .net are also increasingly common.

Typically system architects have stringent performance and other quality requirements their designs must meet. However, it is very difficult for system architects to determine appropriate architecture organisation, middleware and data management choices that will meet these requirements during architecture design. Architects often make such decisions based on their prior knowledge and experience. Various approaches exist to validate these architectural design decisions, such as architecture-based simulation and modelling, performance prototypes and performance monitoring, and visualisation of similar, existing systems.

Simulation tends to be rather inaccurate, performance prototypes require considerable effort to build and evolve, and existing system performance monitoring requires close similarity and often considerable modification to gain useful results.

Many prior art software development tools are based on unified modelling language (UML) to enable a software architect to create virtual models for software systems and architect plans to build. Examples of such UML-based systems include Rational Software's ROSE, Computer Associates' PARADIGM PLUS and Microsoft's VISUAL MODELLER. A further tool available is Collab.Net's Argo/UML, an open source UML modelling solution. Argo/UML and many other existing design systems present features such as UML support, an interactive and graphical software design environment, open standard support and so on. However, many of these existing tools are not architecture focused and provide very uninformative modelling facilities that do not help a software engineer or architecture to make reliable decisions.

One solution is SoftArch/MTE described in “Generation of Distributed System Test Beds from High Level Software Architecture Descriptions” IEEE International Conference on Automated Software Engineering, Nov. 26-29 2001. SoftArch/MTE focuses on software architecture and is aimed at supporting design tool users to make reliable decisions using quantitative evaluation of tentative architecture designs. Two drawbacks of the SoftArch/MTE design tool are that the tool has a poor graphical user interface and that it is not based on UML.

### SUMMARY OF INVENTION

In broad terms in one form the invention comprises a method of generating a high level design of a distributed system test bed comprising the steps of defining a meta-model of the test bed; defining at least two architecture modelling elements within the meta-model to form an architecture model associated with the meta-model; defining at least one relationship between a pair of architecture modelling elements; defining properties associated with at least one of the architecture modelling elements; and storing the high level design in computer memory.

In broad terms in another form the invention comprises a method of generating a performance test bed comprising the steps of defining a high level design of the test bed; generating an XML-encoded architecture design from the high level design; and applying a set of XSLT transformation scripts to the XML-encoded architecture design to generate test bed code.

In broad terms in yet another form the invention comprises a method of defining a meta-model of a distributed system test bed comprising the steps of defining at least two modelling elements within the meta-model; defining at least one relationship between a pair of the modelling elements; and storing the meta-model in computer memory.

In broad terms in yet another form the invention comprises a method of evaluating a performance test bed comprising the steps of defining a high level design of the test bed; generating an XML-encoded architecture design from the high level design; applying a set of XSLT transformation scripts to the XML-encoded architecture design to generate test bed code; deploying the test bed code; signalling test commands; collecting test results; and analyzing the test results to evaluate the performance test bed.

In broad terms in yet another form the invention comprises, in a computer system having a graphical user interface including a display and a selection device, a method of generating a performance test bed, the method comprising the steps of displaying a display panel to a user; receiving a user selection of two or more modelling elements within a meta-model; displaying the modelling elements within the display panel; receiving a user selection for at least one relationship between a pair of the modelling elements; displaying a representation of the at least one relationship between the pair of modelling elements within the display panel; receiving a user selection of two or more architecture modelling elements associated with the modelling elements; displaying the architecture modelling elements within the display panel; receiving a user selection for at least one relationship between a pair of the architecture modelling elements; displaying a representation of the at least one relationship between the pair of the architecture modelling elements; and applying a set of transformation scripts to the architecture modelling elements to generate test bed code.

In broad terms in yet another form the invention comprises, in a computer system having a graphical user interface including a display and a selection device, a method of generating a high level design of a distributed system test bed, the method comprising the steps of defining a meta-model of the test bed; defining at least two architecture modelling elements within the architecture model to form an architecture model associated with the meta-model; defining at least one relationship between a pair of architecture modelling elements; defining properties associated with at least one of the architecture modelling elements; and storing the high level design in computer memory.

In broad terms in yet another form the invention comprises, in a computer system having a graphical user interface including a display and a selection device, a method of defining a meta-model of a distributed system test bed, the method comprising the steps of defining at least two modelling elements within the meta-model; defining at least one relationship between a pair of the modelling elements; and storing the meta-model in computer memory.

In broad terms in yet another form the invention comprises a method of adding performance test bed generation capability to a software design tool comprising the steps of providing means for defining a high level design of the test bed; providing means for generating an XML-encoded architecture design from the high level design; and providing means for applying a set of XSLT transformation scripts to the XML-encoded architecture design to generate test bed code.

In broad terms in yet another form the invention comprises a method of adding high level design generation capability of a distributed system test bed to a software design tool comprising the steps of providing means for defining a meta-model of the test bed; providing means for defining at least two architecture modelling elements within the architecture model to form an architecture model associated with the meta-model; providing means for defining at least one relationship between a pair of architecture modelling elements; providing means for defining properties associated with at least one of the architecture modelling elements; and providing means for storing the high level design in computer memory.

In broad terms in yet another form the invention comprises a method of adding performance test bed evaluation capability to a software design tool comprising the steps of providing means for defining a high level design of the test bed; providing means for generating an XML-encoded architecture design from the high level design; providing means for applying a set of XSLT transformation scripts to the XML-encoded architecture design to generate test bed code; providing means for deploying the test bed code; providing means for signalling test commands; providing means for collecting test results; and providing means for analysing the test results to evaluate the performance test bed.

### BRIEF DESCRIPTION OF THE FIGURES

Preferred forms of the software design system and method will now be described with reference to the accompanying figures in which:

FIG. 1 shows a preferred form flowchart of operation of the invention;

FIG. 2 illustrates a preferred form flowchart of the feature of generating high level design from FIG. 1;

FIG. 3 shows a preferred form user interface initial screen;

FIG. 4 shows the positioning of graphical representations of modelling elements;

FIG. 5 illustrates a sample architecture meta-model;

FIG. 6 illustrates built-in stereotypes;

FIG. 7 illustrates operation properties;

FIG. 8 illustrates the addition of modelling elements by the user;

FIG. 9 illustrates an example architecture design;

FIG. 10 illustrates the property sheet of a modelling element;

FIG. 11 illustrates a further property sheet;

FIG. 12 illustrates an architecture collaboration;

FIG. 13 illustrates a pop-up feature for obtaining all architect collaborations;

FIG. 14 illustrates a further preferred form view of architecture collaboration;

FIG. 15 illustrates an intermediate result of architecture design;

FIG. 16 shows an example fragment of data information of architecture;

FIG. 17 illustrates a code generation process;

FIG. 18 shows a sample structure of a Java-distributed system;

FIG. 19 illustrates a working environment of a deployment tool in a sample system;

FIG. 20 illustrates a preferred form graphical user interface for assigning IP addresses;

FIG. 21 illustrates a preferred form performance testing process;

FIG. 22 illustrates a preferred form result processor tool;

FIG. 23 illustrates a preferred form relational database; and

FIG. 24 illustrates a sample report generated by the invention.

### DETAILED DESCRIPTION OF PREFERRED FORMS

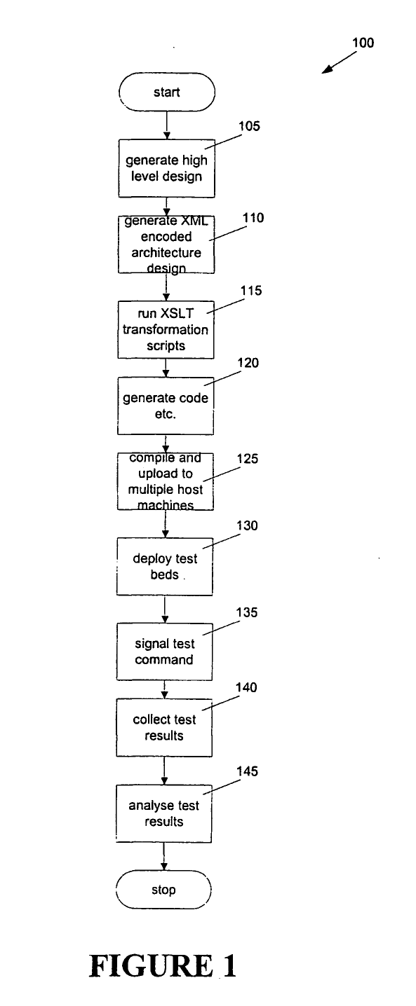

FIG. 1 illustrates a preferred form method 100 of generating a distributed system test bed in accordance with the invention. The first step is to generate 105 a high level design of a distributed system test bed. The preferred form generation involves a two step process in which a software architect defines a meta-model of the test bed initially and then defines one or more architecture models or modelling elements that are compatible with the meta-model. Each architecture model design is associated with an architecture meta-model and each architecture design may have one or more architecture models based on that meta-model.

The invention provides a software tool to enable a user to create a new meta-model or to load an existing meta-model from computer memory before going to architecture design. The process of generating high level design is further described below.

Using the high level design generated at step 105 above, the invention generates 110 an XML-encoded architecture design. The invention traverses the architecture design used to generate XML-encoding of the design.

The invention runs 115 a set of XSLT transformation scripts in order to generate 120 various parts of the XML into program source code, IDLs, deployment descriptors, compilation scripts. deployment scripts, database table construction scripts and so on.

XML is used to save intermediate results for test bed generation, as well as architecture models for future data exchange and tool integration. The invention preferably uses XML as the main standard for data exchange and data storage to facilitate integration with third party tools and use of third party software.

Client and server program code is compiled 125 automatically by the invention using generated compilation scripts to produce fully functional deployable test bed code.

One preferred form of the invention uses a deployment tool that loosely couples with the test bed generator to perform three key tasks, namely deploy 130 test beds, signal 135 test commands and collect 140 test results. It is envisaged that tool users are able to manage multiple computers, deploy generated test beds that include source files, DOS batch files, database files and so on to any managed computer, manage the execution conditions of each affected computer and collect all test results.

The invention may also include a result processor enabling a user to store all test results in a relational database for example, and to analyse 145 data of interest in visualised test results.

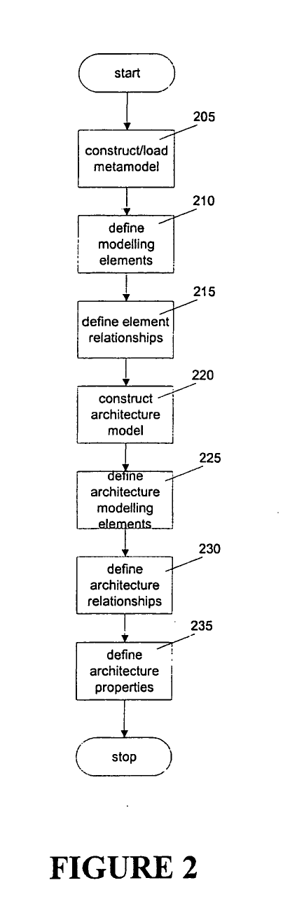

FIG. 2 illustrates a preferred form two step process of generating high level design from FIG. 1. The invention preferably includes a modelling component that is configured to enable a user to create a graphical representation of a meta-model initially then a graphical representation of one or more architecture models.

The invention permits a user to construct 205 a new meta-model of the test bed or alternatively to load an existing meta-model before proceeding to construct or design an architecture model. The components and connectors defined in the meta-model are then used as modelling types and constraints in the architecture model.

Users generally create a new architecture meta-model which is normally a domain-specific meta-model. In this way the architecture meta-model is associated with the meta-model. Alternatively, a user could load an existing meta-model stored in computer memory. Each meta-model contains one architecture meta-model and may also contain one or more architecture models, thereby enabling a user of the system to reuse domain-specific knowledge in order to evaluate various architecture designs.

The user defines 210 one or more modelling elements within a meta-model. It is envisaged that there are three main modelling elements, for example architecture meta-model host, architecture meta-model operation host and architecture meta-model attribute host. Each component focuses on a particular set of tasks and models a domain-specific entity or type that is used to describe architecture design.

The user then defines 215 relationships between one or more pairs of modelling elements that represent constraints. Preferably one or more of the elements is associated with a set of properties. The invention preferably has stored in computer memory a set of built in stereotypes, each stereotype representing a standard set of properties. The meta-model is then stored in computer memory.

Having defined, either by construction or loading, a meta-model, the user constructs 220 an architecture model. In practice, the user may construct one or more architecture models, each architecture model associated with a particular meta-model.

An architecture model will typically have three architecture modelling elements, namely architecture host, architecture operation host and architecture attribute host. Each of these architecture modelling elements represents a detailed entity involved in system architecture. Roles and characters of each entity are defined by a component property sheet.

The user defines 225 one or more architecture modelling elements. The user then defines 230 relationships between one or more pairs of architecture modelling elements.

Having defined architecture modelling elements and relationships between these elements, the user then defines 235 architecture modelling element properties associated with at least one of the architecture modelling elements. The invention preferably permits a user to set up design and testing parameters for subsequent test bed generation and performance evaluation. The invention preferably displays to a user a property sheet of one or more of the architecture modelling elements. This property sheet can include one or more testing parameters to which sensible values can be assigned.

The high level design is then stored in computer memory. The invention permits users to set up design/testing parameters for behaviours of modelling components, where behaviours include operations and attributes.

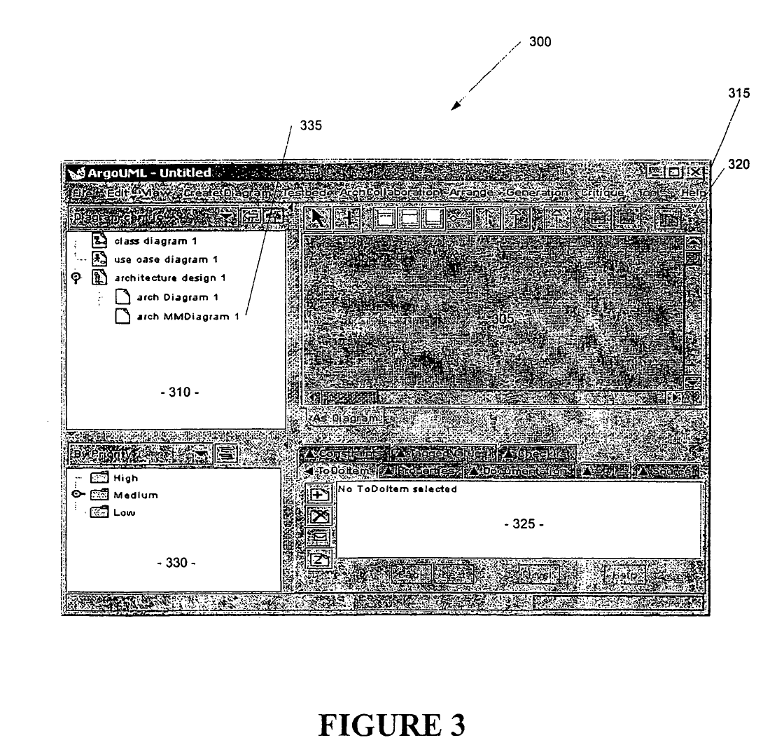

A preferred form modelling component configured to enable a user to construct or load a meta-model will now be described with reference to FIGS. 3-14.

FIG. 3 shows an initial screen 300 of a preferred form user interface that enables a user to create a new architecture design. It will be appreciated that the configuration and layout of the user interface may vary but still retain the same function or functions. The preferred form display includes a display panel 305 and a file name panel 310. It may also include a menu bar 315, a tool bar 320, an information window 325 and a display hierarchy window 330.

It is anticipated that the preferred form user interface will be designed to run on conventional computer hardware. Such hardware typically includes a display configured to display a graphical representation to a user, for example a standard LCD display or computer monitor. The computer system will also typically include a selection device, for example a mouse, touch sensitive keypad, joy stick or other similar selection device.

FIG. 3 illustrates an empty design as shown in display panel 305. The design contains one architecture meta-model labelled as “arch MMdiagram 1” 335 in the file name panel 310.

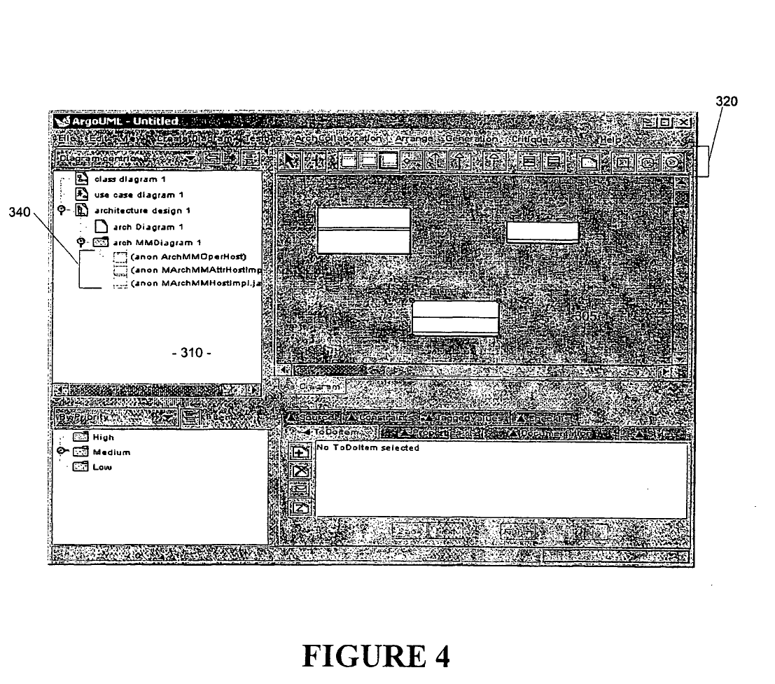

As shown in FIG. 4, the user clicks icons in the toolbar 320 in order to position graphical representations of one or more modelling elements in the display panel 305. Labels for each of the elements shown in display panel 305 are listed in the file name panel 310 as shown at 340.

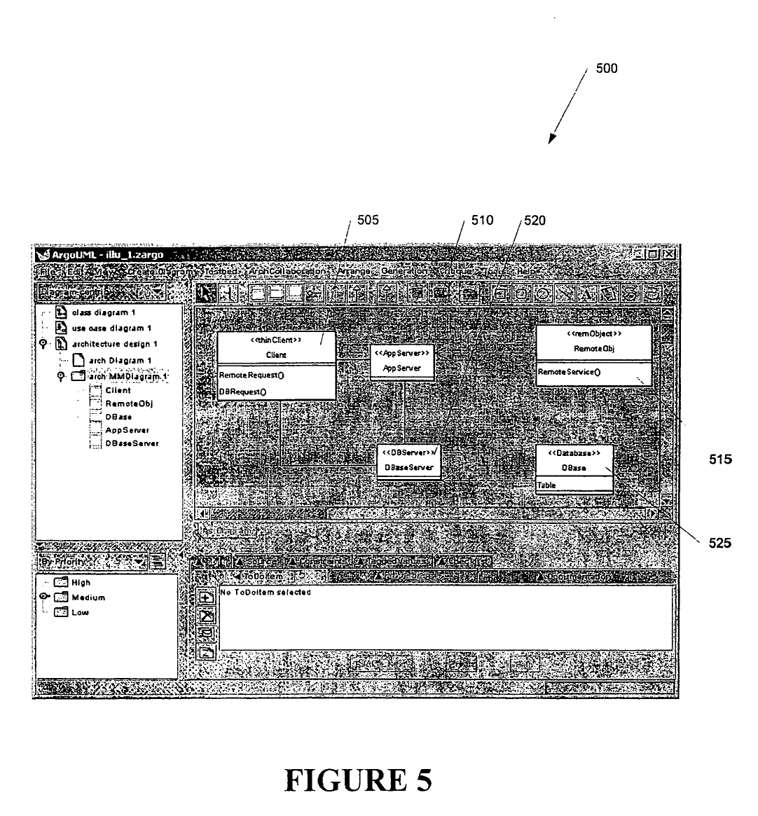

FIG. 5 illustrates a sample architecture meta-model constructed in accordance with the invention. The model 500 defines five different elements involved in an e-commerce software architecture. This sample meta-model is in the field of e-commerce. The meta-model is able to provide fundamental type information and constraint information regardless of the intended application of the system.

Meta-model 500 defines five different modelling elements, namely client 505, App Server 510, Remote Obj 515, DBase Server 520 and Dbase 525. Each of the elements are shown connected to one or more other elements by respective connectors. These connectors represent constraints among types. One example of a constraint is that client 505 may issue a Remote Request and a DB Request, another is that Remote Obj 515 provides Remote Service. Further constraints are that DBase 525 holds a table, client 505 contacts with Remote Obj 515 via APP Server 510. Furthermore, all database operations are handled through DBase Server 520.

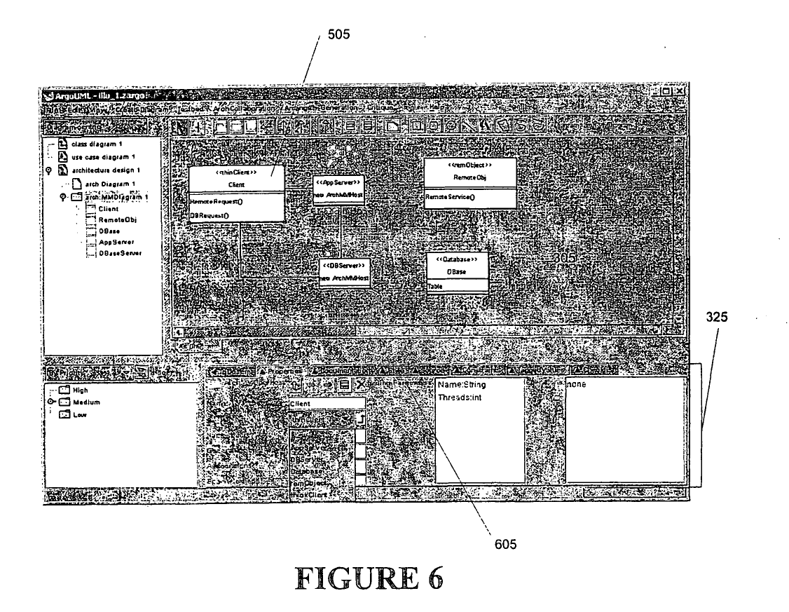

FIG. 6 illustrates a preferred form feature of component properties and the use of built-in stereotypes.

When a model element is selected or highlighted in display panel 305, the property or properties associated with that model element are shown in the information window 325.

In FIG. 6, the client 505 is shown as selected or highlighted so the properties of the client 505 are displayed in the information window 325. In the example, client 505 uses a stereotype “thinClient” that is one of a pre-defined set of stereotypes. The client component is specified by two testing parameters 605, namely Name and Threads. The use of such built-in stereotypes to carry code generation information enriches the flexibility of test bed generation.

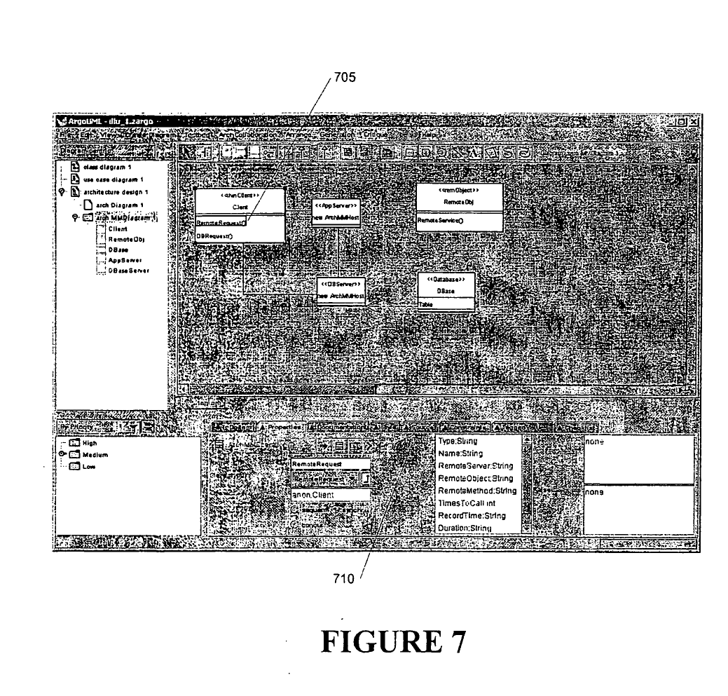

Referring to FIG. 7, each graphical representation of an element includes a label, for example “client”, and a stereotype label for example “thin Client”. The graphical representation could also include constraint labels, for example “Remote Request” and “DB Request”.

In one preferred form of the invention, each of the constraint types that include operations and attributes can be considered as second level modelling elements and these second level elements could also be defined by design/testing parameters.

As shown in FIG. 7, the operation “Remote Request” shown at 705 is specified by a set of testing parameters indicated at 710 that include Type, Name, Remote Server, Remote Method and so on. It is envisaged that these stereotype and testing/design parameters carry important information for test bed generation.

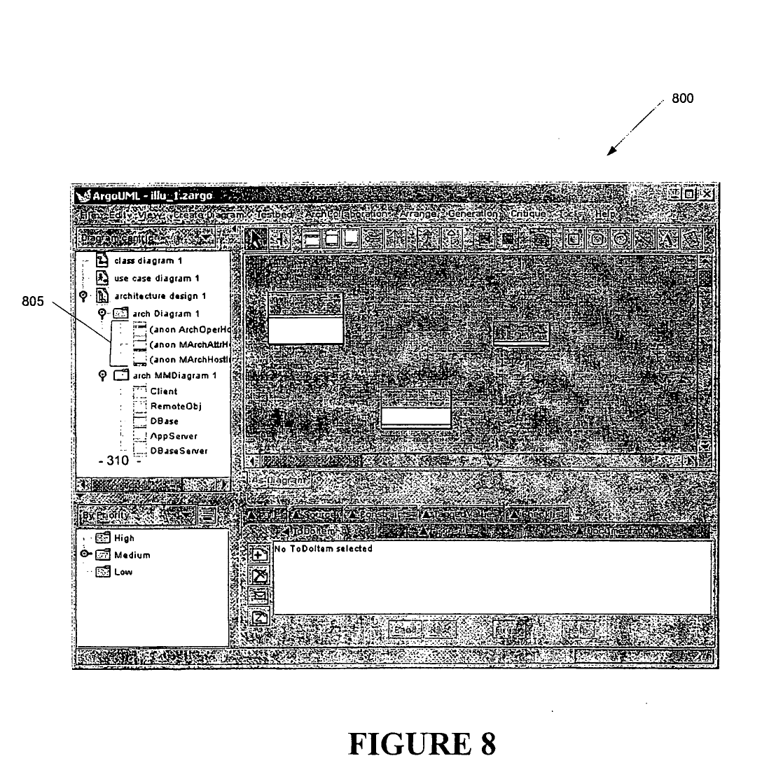

After a meta-model has been created or loaded, architecture modelling elements can then be added to the diagram by clicking on various icons in the toolbar. FIG. 8 illustrates the step of adding modelling components shown at 800. As elements are added to display panel 305, labels for these elements are added to the file name panel 310 as indicated at 805.

In FIG. 8 the three main modelling elements illustrated are architecture host, architecture operation host and architecture attribute host.

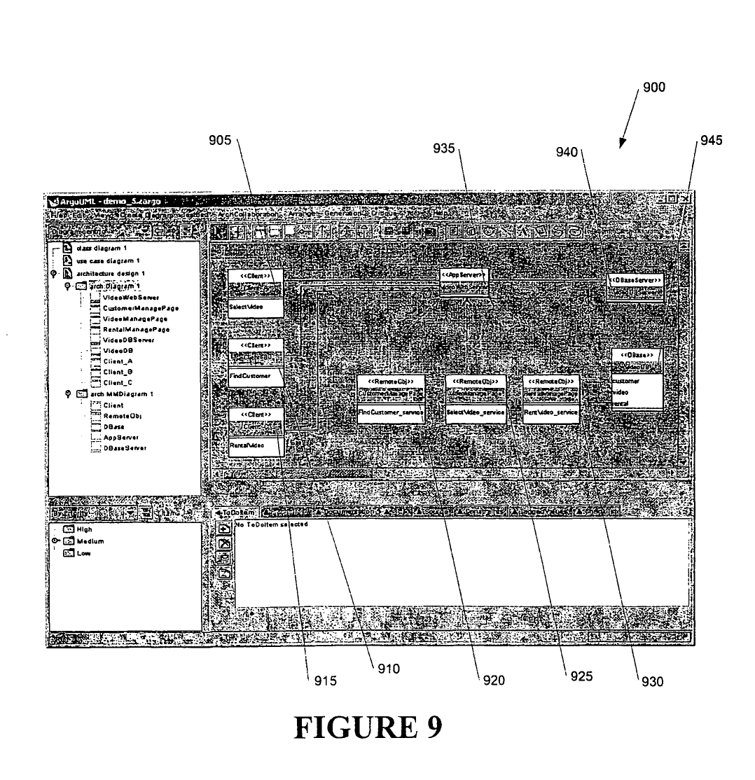

FIG. 9 illustrates an example architecture design generated in accordance with the invention. The design 900 may include a plurality of architecture modelling elements, for example three clients namely Client A 905, Client B 910, Client C 915 and three remote objects, namely customer manage page 920, video manage page 925 and rental manage page 930. The model 900 may also include an application server video web server 935, a database server VideoDB server 940 and a database VideoDB 945.

As shown in FIG. 9. all clients 905, 910 and 915 can contact with video web server 935. Video web server 935 manages customer manage page 920, video manage page 925 and rental manage page 930. Video web server 935 can contact with VideoDB server 940 which in turn manages database VideoDB 945.

Each client exposes one or more operations. Video web server 935 does not execute business operations but provides system level services. Each remote object 920, 925 and 930 provide remote services. A database 945 holds one or more tables.

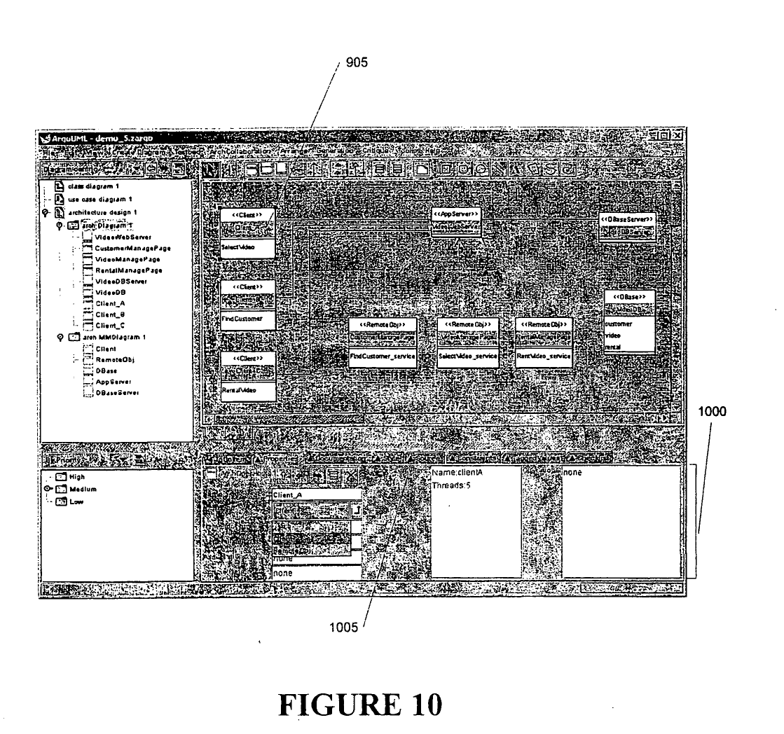

FIG. 10 illustrates at 1000 the property sheet of modelling element Client A 905. The element 905 is typed by “client” meta-type, which is in turn defined in the meta-model to represent the common character of the client in the e-commerce domain. Client A 905 is specified by two testing parameters, for example Name and Threads. Sensible values can then be assigned to these two parameters.

The invention also permits users to set up design/testing parameters for behaviours that include operations and attributes of modelling components.

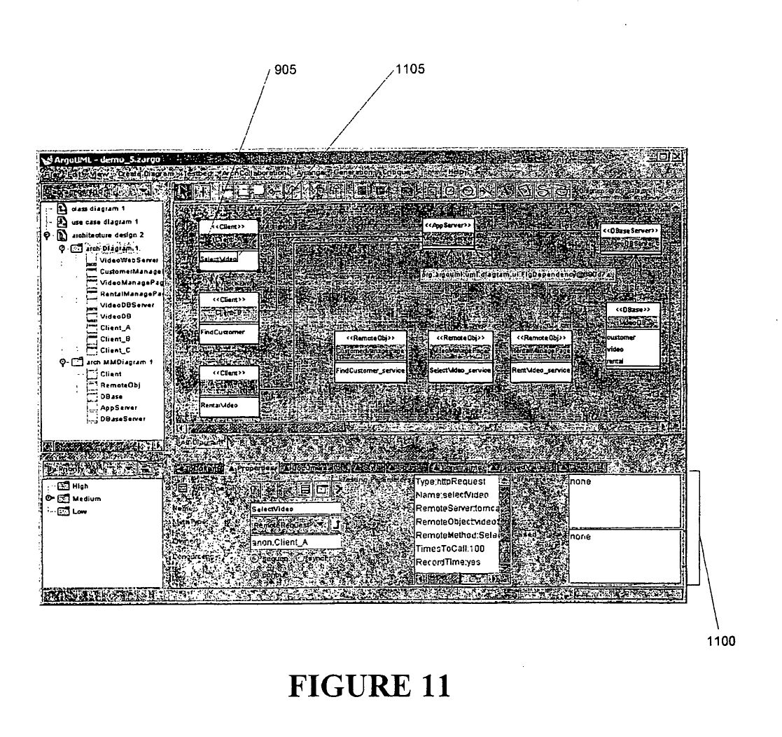

FIG. 11 illustrates at 1100 the property sheet of the operation SelectVideo 1105 of the component Client A 905. SelectVideo 1105 is typed by the “remote request” meter type that is defined in the meta-model to represent the common character of remote operation in the e-commerce domain. SelectVideo 1105 could also be specified by many design/testing parameters, such as type, name, remote server and so on.

It is also envisaged that the invention permit a user to define collaboration flow in architecture design, that helps a user to organise and analyse all collaborations.

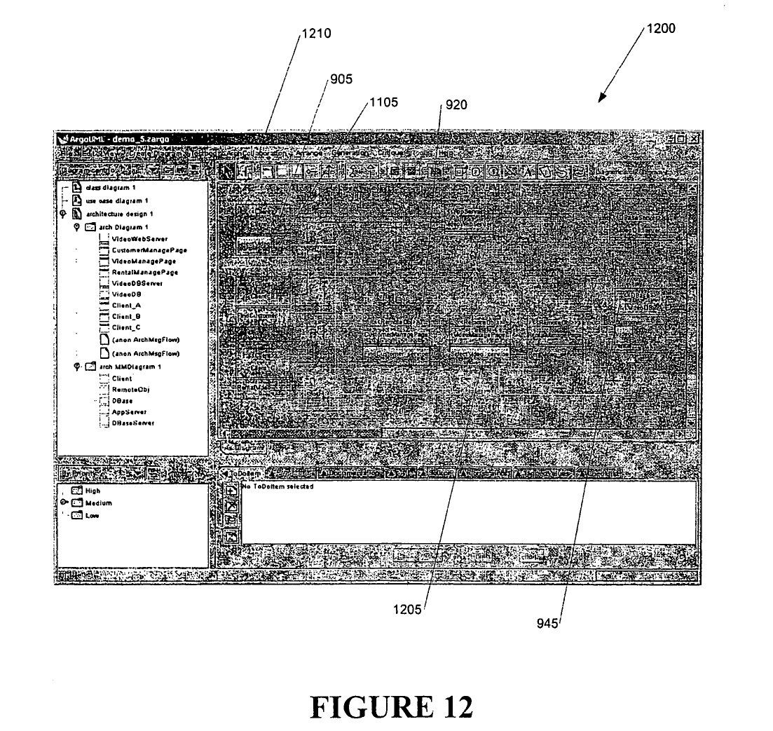

FIG. 12 shows an arch collaboration 1200 on the background of a dimmed architecture model.

It is clear in FIG. 12 that three elements are involved in the collaboration, namely Client A 905, CustomerManagePage and VideoDB 945. More specifically, the collaboration models the communications among operation SelectVideo 1105, operation SelectVideo_Service 1205 of VideoManagePage and attribute “customer” of VideoDB 945.

By selecting menu item ArchCollaborationDone from ArchCollaboration from the menu bar, a user may finish the design of the current collaboration. The architecture design diagram is transformed back to a normal state and a pop-up menu item can be inserted to all modelling involved in that collaboration which in the case of FIG. 12 will be Client A 905, customer manage page 920 and VideoDB 945.

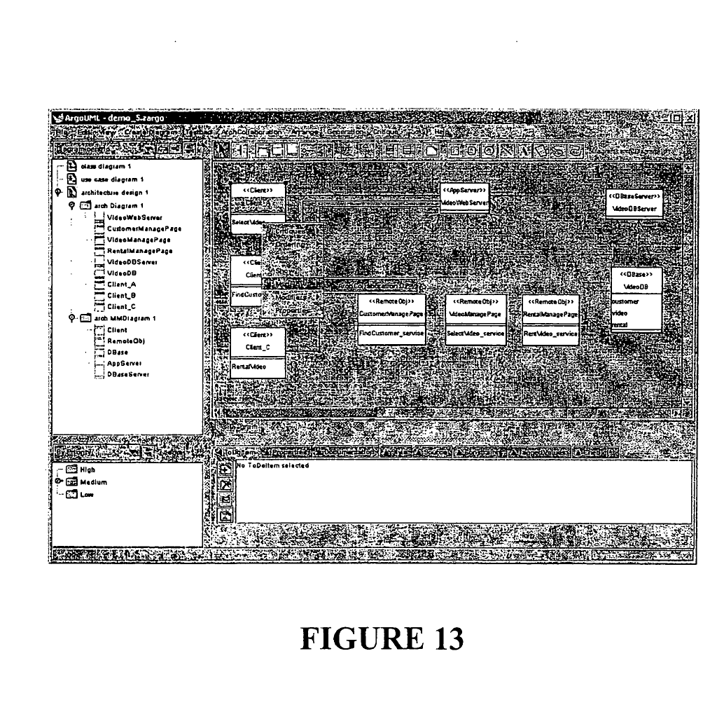

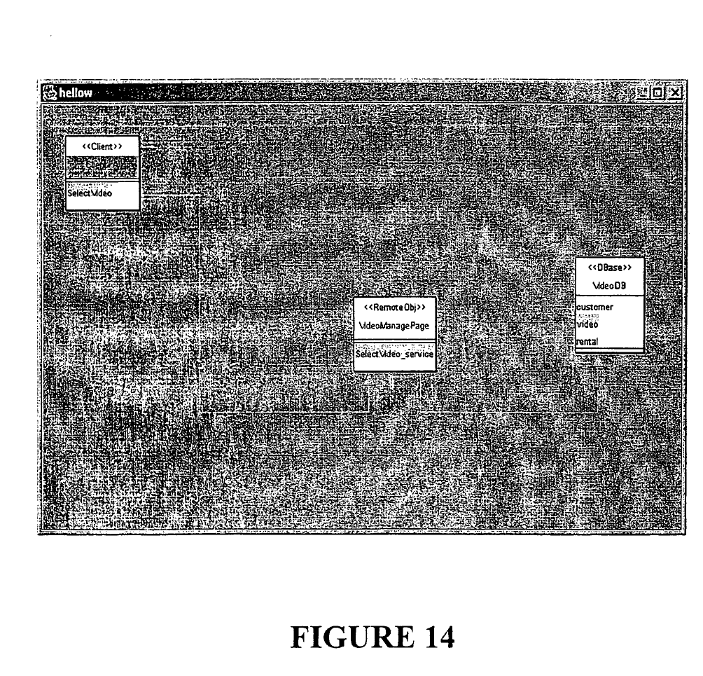

It is also envisaged that users of the system could obtain all architect collaborations by checking the modelling elements pop-up menu as shown in FIG. 13. By clicking a pop-up menu item, users could display the view of the architect collaboration corresponding to that menu item. Alternatively, as shown in FIG. 14, a different view on the architecture collaboration created in FIG. 12 could be shown as a single model multi-view.

Having generated a high level design, the invention is arranged to use XML to save intermediate results for test bed generation, in addition to architecture models for future data exchange and tool integration.

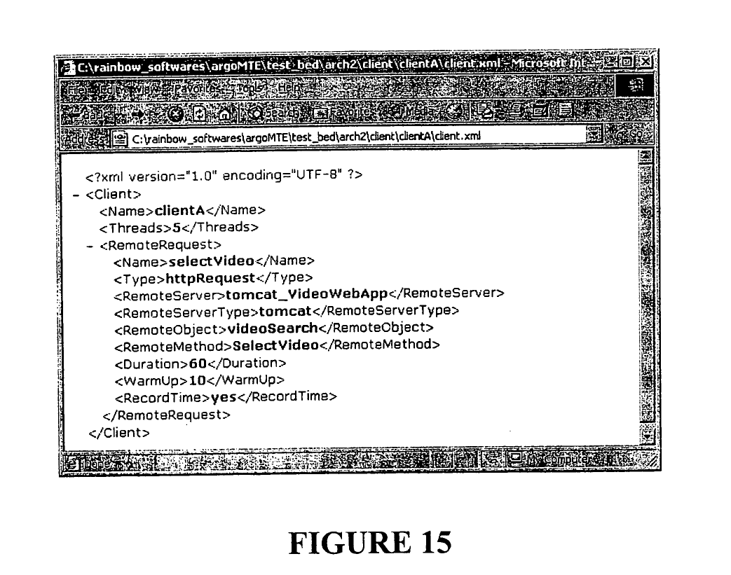

FIG. 15 illustrates an intermediate result of architecture design. Intermediate results are preferably generated during a process of architecture design and performance evaluation. The invention uses XML to encode most of the important results. FIG. 15 illustrates the XML encoding design information of a modelling component. This encoded information provides a base for test bed generation.

The saved architecture models of the invention preferably have a distinctive file extension, for example “.zargo”. Each data file preferably contains view information and data information. View information records all diagram drawing information whereas data information, in the form of an XML file, records design data model, base model and net model.

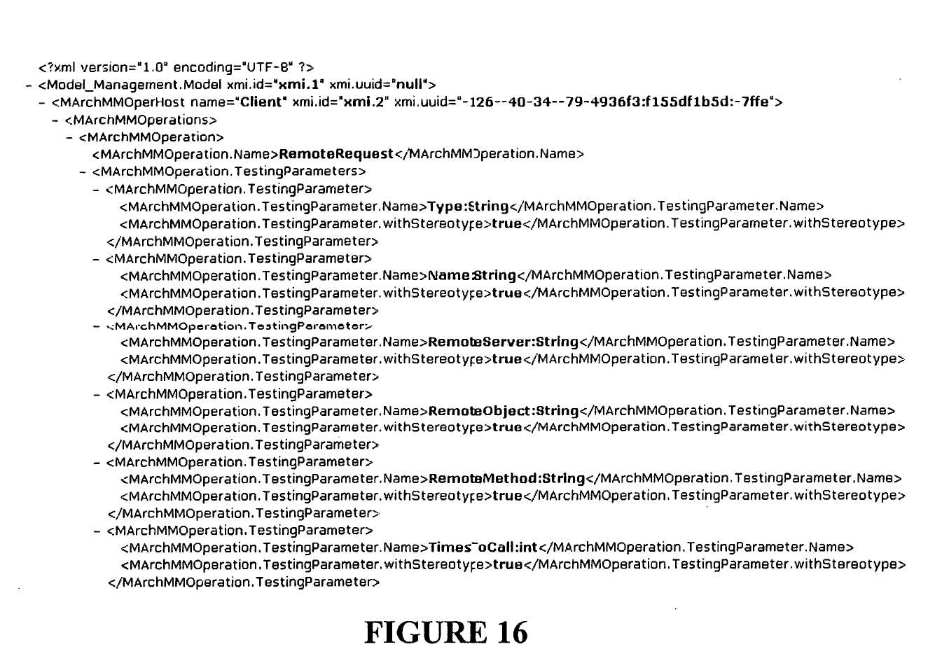

FIG. 16 illustrates an example fragment of data information of architecture designed from FIG. 10.

It is envisaged that the invention use XML as the main standard for data exchange and data storage, facilitating integration with third party tools and the use of third party software.

XMI is a standard to encode UML designs/diagrams, for example UML class diagrams, use case diagrams and so on. An XMI file is an XML file with UML specific tags. The invention preferably uses XMI to encode all of its designs. The invention uses an extended XMI to encode architecture together with performance test bed generation information.

The invention preferably generates fully functional test beds for any trial design and compiles test beds with minimal effort from a system user.

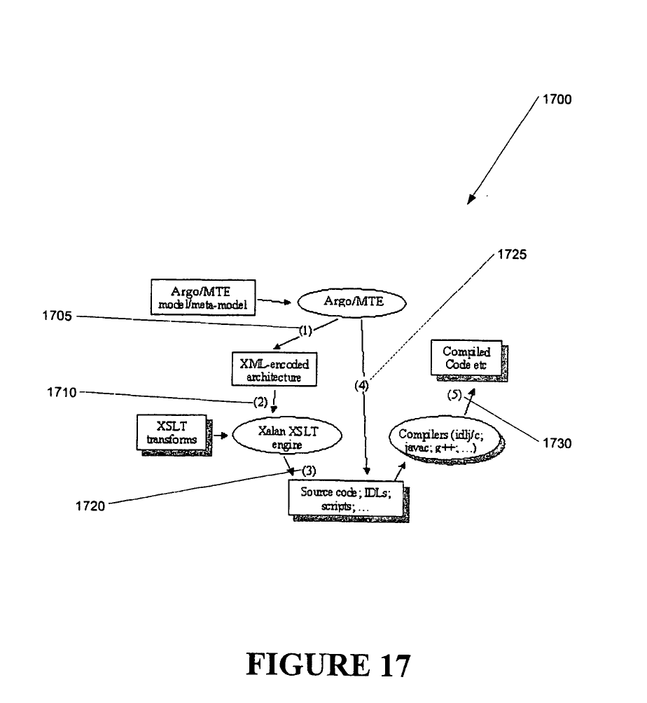

FIG. 17 illustrates at 1700 the code generation process used by one preferred form of the invention. The invention traverses the architecture design using element/connector types and meta-model data to generate 1705 a full XML encoding of the design. A set of XSLT transformation scripts and an XSLT engine 1710 transform various parts of the XML into program source code, IDLs, deployment descriptors, compilation scripts, deployment scripts, database table construction and population scripts and so on 1720. Client and server program code is then compiled automatically by the invention using generated compilation scripts 1725 to produce fully functional deployable test bed code 1730.

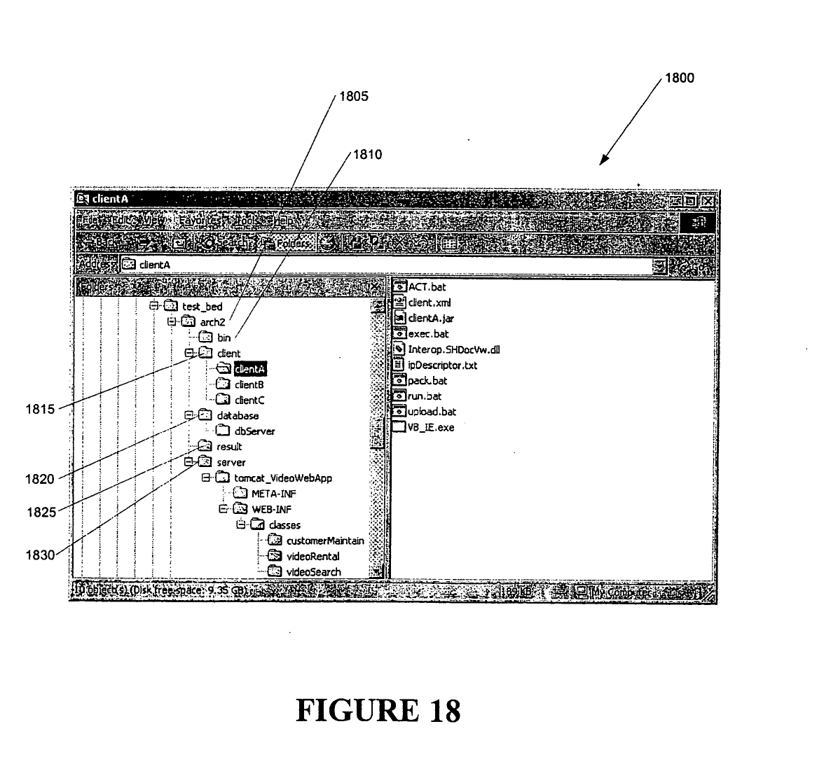

FIG. 18 illustrates the structure of a sample Java distributed system 1800. Within the directory of arch2 indicated at 1805, there are positioned five directories including bin 1810, client 1815, database 1820, result 1825 and server 1830.

All directories except result 1825 contain application Java files, DOS batches, CORBA idl files and so on. Arch 1805 is preferably a fully functional distributed system that can generate useful and reliable performance evaluation results.

It is envisaged that the invention support any known middleware technology, for example j2EE, .net, CORBA, RMI, JSP and both thin and thick client.

It is also envisaged that the invention provide a deployment tool that loosely couples a test bed generator of the invention to the deployment tool to perform three key tasks, namely deploy test beds, signal test command and collect test results.

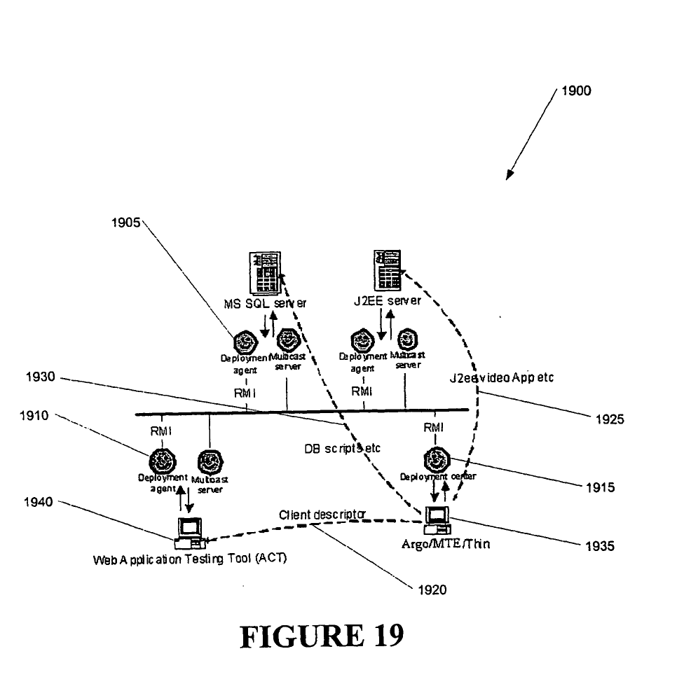

FIG. 19 illustrates a working environment 1900 of the deployment tool in a simplified video rental system.

The deployment agents, for example RMI servers 1905, 1910 and 1915, are installed on machines that host parts of a test bed including client descriptor 1920, J2EE web application 1925 and database scripts 1930.

The deployment centre is installed on the machine that hosts Argo/MTE/Thin 1935. The deployment centre issues multicast requests to collect IP addresses of all machines.

A graphical user interface for assigning IP addresses enables system users to assign different parts of a test bed to available machines.

The deployment centre then takes action to upload a test bed. The centre packs each part of a test bed as a Java archive file (JAR file), then uploads the file to the target machine and unpacks it. If the uploaded file is a J2EE web application, a batch file is executed to deploy the web application on the local J2EE server. If the uploaded file contains database scripts, these scripts are executed to create or populate a database.

The deployment centre then signals a start test command. The deployed client (ACT) 1940 is executed to send HTTP requests to the J2EE web application, and record the results on the local disks.

The deployment centre then signals a collect results command. The test results that are stored on the client deployed machine are then collected.

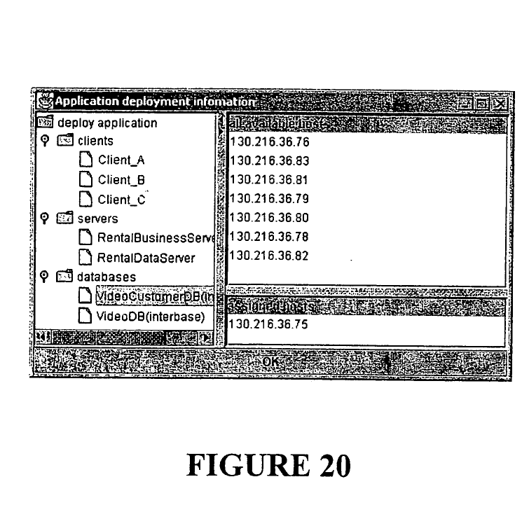

FIG. 20 illustrates a preferred form graphical user interface for assigning IP addresses. By dragging and dropping, a user can deploy any part of an application or test bed to a remote computer.

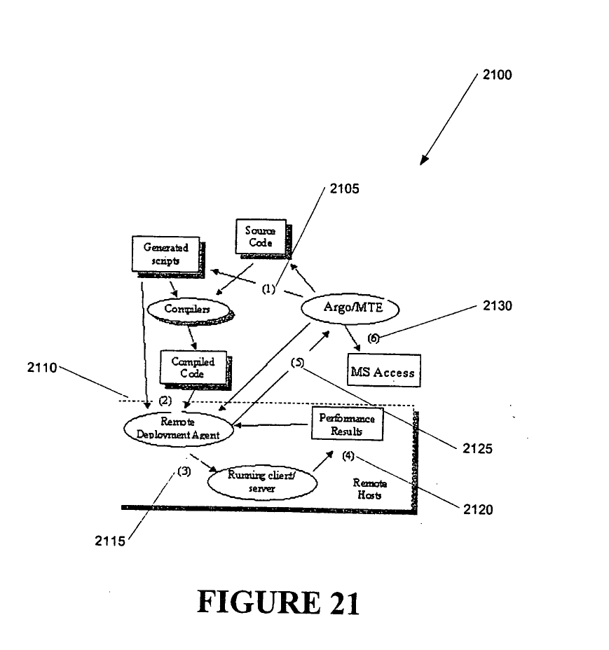

FIG. 21 outlines the performance testing process 2100. A test bed is compiled using the invention with generated compilation scripts 2105. The compiled code, IDLs, descriptors and scripts are then deployed/run on a host and then uploaded to a remote client and server hosts using remote deployment agents 2110.

The client and server programs are then run, server programs are started, database servers are started, and database table initialisation scripts are run. The clients are then started 2115. Clients look up their servers and then await the invention to send a signal, via their deployment agent, to run or may start execution at a specified time.

Clients run their server requests, typically logging performance timing results for different requests to a file 2120. The servers do the same. Third party performance measuring tools can also be deployed to capture performance information, and are configured by the invention generated scripts. Performance results are then sent back to the invention for visualisation indicated at 2125, possibly using third party tools such as Microsoft Access 2130.

A deployment tool makes it possible for the invention to manage a real distributed testing environment. By using a deployment tool, a system user can deploy test beds to remote computers and manage operations of the deployed test bed. Only when a test bed is running in a real distributed environment can the testing results be reliable.

One preferred form of the invention includes a result processor enabling a user to store all test results in a relational database, analyse interesting data, and visualise the test results.

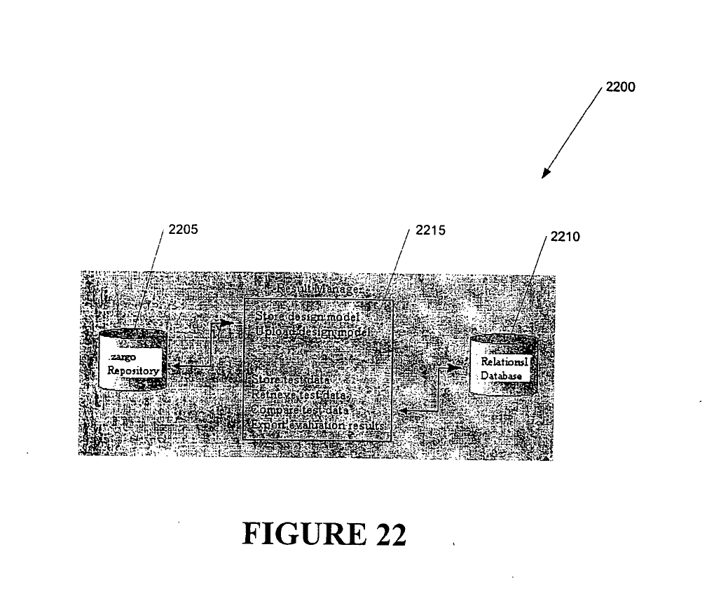

FIG. 22 illustrates at 2200 the structure of a preferred form result processor tool. The preferred tool contains three main parts, including a Zargo file repository 2205, a relational database 2210, and an application result manager 2215.

The result manager 2215 is an application that operates with the .zargo file repository and the database. The result manager stores data to the database, retrieves data from the database, and exports data to third party tools.

A .zargo file repository is needed to hold design models, for example .zargo files. When a user wants to analyse historical design/data, the user can easily upload the design model and match the model with recorded testing results.

A relational database can also be used to store and organise performance testing results.

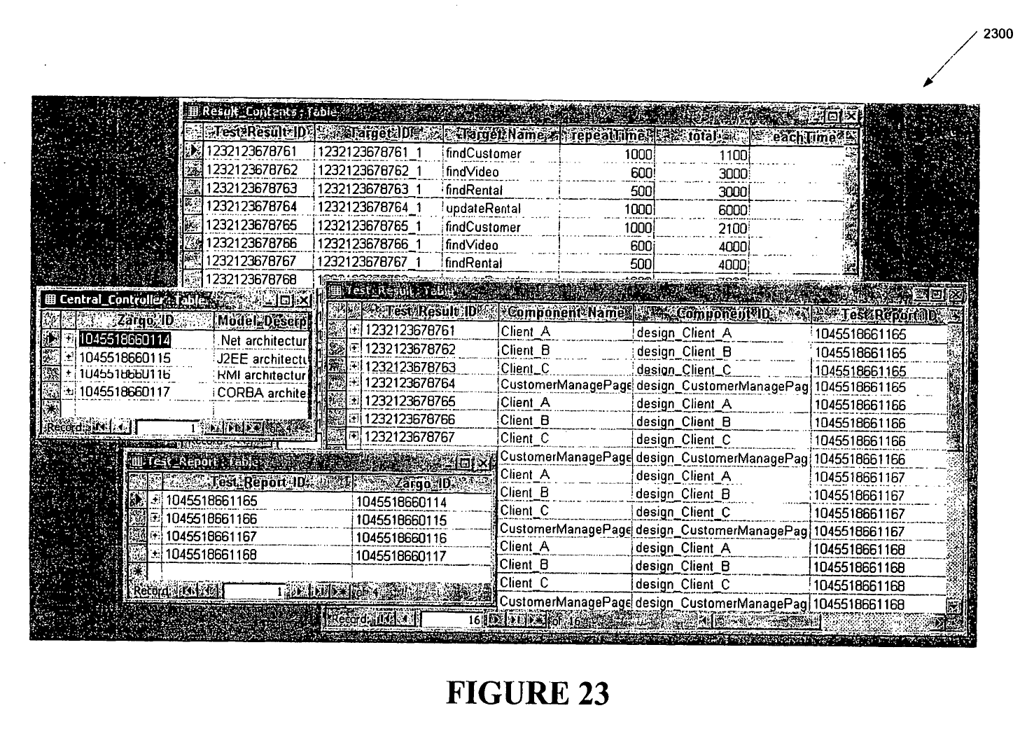

FIG. 23 illustrates a preferred form relational database 2300 supported by the result processor tool. The database preferably holds .zargo file repository information, test report information, test result information and result contents information.

The result processor tool assumes that each design model, stored in the format of a .zargo file. can be tested many times and each test generates a test report. Each test report may contain many test results. Each test result may contain many test targets and testing parameters.

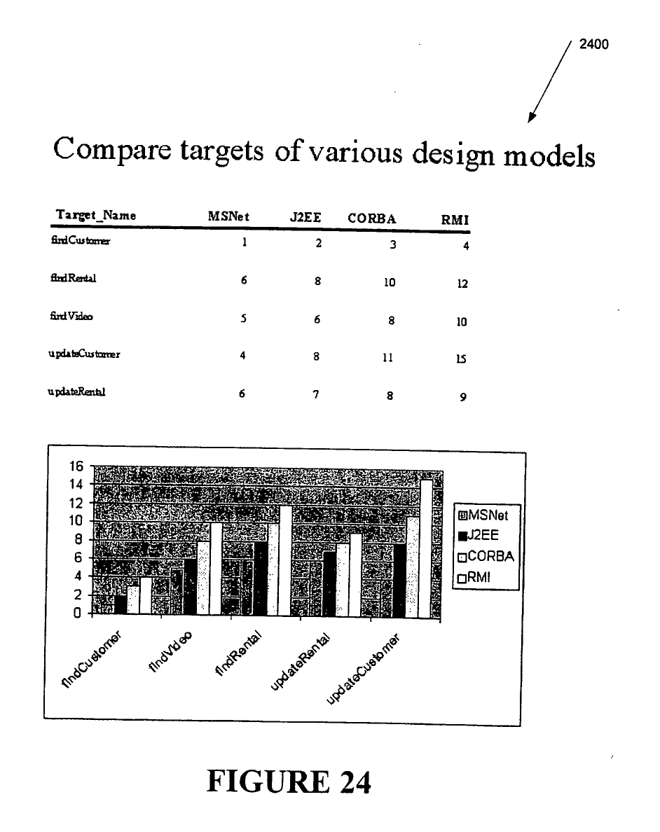

FIG. 24 illustrates at 2400 a sample report generated by the invention. This report contains a table of data and a simple chart. The table gathers test results of four architecture designs based on MS, .Net, J2EE, CORBA and RMI respectively. The evaluation targets represent the characters/behaviours of architecture modelling components. The report provides a user friendly way for software engineers to review all trial architecture designs and make final decisions.

In summary, the invention provides:

An extension of a standard UML design tool to add software architecture modelling and properties support for performance test bed generation

An extension of existing XML encoding of UML (XMI) to encode software architecture model and properties for performance test bed generation

The use of XSLT to transform this extended XML model into generated performance test bed code and deployment/configurations scripts

A new architecture for code generation, generated test bed code & scripts, and performance capture. This approach includes use of an application test centre for thin client test bed interfaces, database capture and visualisation of results.

The foregoing describes the invention including preferred forms thereof. Alterations and modifications as will be obvious to those skilled in the art are intended to be incorporated within the scope hereof, as defined by the accompanying claims.

1. A method of generating a high level design of a distributed system test bed comprising the steps of:
defining a meta-model of the test bed;
defining at least two architecture modelling elements within the meta-model to form an architecture model associated with the meta-model;
defining at least one relationship between a pair of architecture modelling elements;
defining properties associated with at least one of the architecture modelling elements; and
storing the high level design in computer memory.

2. A method as claimed in claim 1 wherein at least one architecture modelling element comprises an architecture host.

3. A method as claimed in claim 1 wherein at least one architecture modelling element comprises an architecture operation host.

4. A method as claimed in claim 1 wherein at least one architecture modelling element comprises an architecture attribute host.

5. A method of generating a performance test bed comprising the steps of:
defining a high level design of the test bed;
generating an XML-encoded architecture design from the high level design; and
applying a set of XSLT transformation scripts to the XML-encoded architecture design to generate test bed code.

6. A method as claimed in claim 5 further comprising the steps of:
applying the set of XSLT transformation scripts to generate program source code and compilation scripts; and
compiling the program source code using the compilation scripts to generate the test bed code.

7. A method of defining a meta-model of a distributed system test bed comprising the steps of:
defining at least two modelling elements within the meta-model;
defining at least one relationship between a pair of the modelling elements; and
storing the meta-model in computer memory.

8. A method as claimed in claim 7 wherein at least one modelling element comprises an architecture meta-model host.

9. A method as claimed in claim 7 wherein at least one modelling element comprises an architecture meta-model operation host.

10. A method as claimed in claim 7 wherein at least one modelling element comprises an architecture meta-model attribute host.

11. A method of evaluating a performance test bed comprising the steps of:
defining a high level design of the test bed;
generating an XML-encoded architecture design from the high level design;
applying a set of XSLT transformation scripts to the XML-encoded architecture design to generate test bed code;
deploying the test bed code;
signalling test commands;
collecting test results; and
analyzing the test results to evaluate the performance test bed.

12. In a computer system having a graphical user interface including a display and a selection device, a method of generating a performance test bed, the method comprising the steps of:
displaying a display panel to a user;
receiving a user selection of two or more modelling elements within a meta-model;
displaying the modelling elements within the display panel;
receiving a user selection for at least one relationship between a pair of the modelling elements;
displaying a representation of the at least one relationship between the pair of modelling elements within the display panel;
receiving a user selection of two or more architecture modelling elements associated with the modelling elements;
displaying the architecture modelling elements within the display panel;
receiving a user selection for at least one relationship between a pair of the architecture modelling elements;
displaying a representation of the at least one relationship between the pair of the architecture modelling elements; and
applying a set of transformation scripts to the architecture modelling elements to generate test bed code.

13. A method as claimed in claim 12 further comprising the steps of:
applying the set of transformation scripts to generate program source code and compilation scripts; and
compiling the program source code using the compilation scripts to generate the test bed code.

14. In a computer system having a graphical user interface including a display and a selection device, a method of generating a high level design of a distributed system test bed, the method comprising the steps of:
defining a meta-model of the test bed;
defining at least two architecture modelling elements within the architecture model to form an architecture model associated with the meta-model;
defining at least one relationship between a pair of architecture modelling elements;
defining properties associated with at least one of the architecture modelling elements; and
storing the high level design in computer memory.

15. In a computer system having a graphical user interface including a display and a selection device, a method of defining a meta-model of a distributed system test bed, the method comprising the steps of:
defining at least two modelling elements within the meta-model;
defining at least one relationship between a pair of the modelling elements; and
storing the meta-model in computer memory.

16. A method of adding performance test bed generation capability to a software design tool comprising the steps of:
providing means for defining a high level design of the test bed;
providing means for generating an XML-encoded architecture design from the high level design; and
providing means for applying a set of XSLT transformation scripts to the XML-encoded architecture design to generate test bed code.

17. A method of adding high level design generation capability of a distributed system test bed to a software design tool comprising the steps of:
providing means for defining a meta-model of the test bed;
providing means for defining at least two architecture modelling elements within the architecture model to form an architecture model associated with the meta-model;
providing means for defining at least one relationship between a pair of architecture-modelling elements;
providing means for defining properties associated with at least one of the architecture modelling elements; and
providing means for storing the high level design in computer memory.

18. A method of adding performance test bed evaluation capability to a software design tool comprising the steps of:
providing means for defining a high level design of the test bed;
providing means for generating an XML-encoded architecture design from the high level design;
providing means for applying a set of XSLT transformation scripts to the XML-encoded architecture design to generate test bed code;
providing means for deploying the test bed code;
providing means for signalling test commands;
providing means for collecting test results; and
providing means for analysing the test results to evaluate the performance test bed.
